(19) United States
(12) Patent Application Publication
(10) Pub. No.: US 2017/0293802 A1
(43) Pub. Date: Oct. 12, 2017

(54) IMAGE PROCESSING DEVICE AND IMAGE PROCESSING METHOD

(71) Applicant: FUJITSU LIMITED, Kawasaki-shi (JP)

(72) Inventors: Susumu Endo, Kawasaki (JP); Masaki ISHIHARA, Kawasaki (JP); Masahiko SUGIMURA, Kawasaki (JP); Hiroaki TAKEBE, Kawasaki (JP); Takayuki BABA, Kawasaki (JP); Yusuke UEHARA, Kawasaki (JP)

(73) Assignee: FUJITSU LIMITED, Kawasaki-shi (JP)

(21) Appl. No.: 15/457,138

(22) Filed: Mar. 13, 2017

(30) Foreign Application Priority Data
Apr. 7, 2016 (JP) 2016-077227

(51) Int. Cl. G06K 9/00; G06T 7/136; G06T 7/12; G06T 7/13; G06T 7/174

(52) U.S. Cl. CPC G06K 9/00724; G06T 7/13; G06T 7/174; G06T 7/12; G06T 7/136; G06T 2207/10016; G06T 2207/30196; G06T 2207/30221

(57) ABSTRACT

A memory stores area information indicating a pitcher area in which a pitcher is presumed to appear in an image that represents a pitching scene. A processor detects an edge pixel from a difference image that represents a difference between a first image at a first time and a second image at a second time that are included in a video, and identifies an edge area in which a plurality of edge pixels are aligned in a prescribed direction in the difference image. Then, the processor determines that the difference image represents the pitching scene on the basis of a size of the edge area included in the pitcher area indicated by the area information in the difference image and on the basis of a size of the edge area included in a prescribed area in the difference image.

### CROSS-REFERENCE TO RELATED APPLICATION

This application is based upon and claims the benefit of priority of the prior Japanese Patent Application No. 2016-077227, filed on Apr. 7, 2016, the entire contents of which are incorporated herein by reference.

### FIELD

The embodiments discussed herein are related to an image processing device and an image processing method.

### BACKGROUND

A video of a baseball game may be shot for, for example, a professional baseball game relay broadcast on TV, and the video may be stored. The stored video of a baseball game is used for, for example, rebroadcasting. Further, a variety of image processing for a video of a baseball game is known (see, for example, Patent Documents 1 to 3).
Patent Document 1: Japanese Laid-open Patent Publication No. 2003-52003
Patent Document 2: Japanese Laid-open Patent Publication No. 2006-203498
Patent Document 3: Japanese Laid-open Patent Publication No. 2015-139015

### SUMMARY

According to an aspect of the embodiments, an image processing device includes a memory and a processor coupled to the memory. The memory stores area information indicating a pitcher area in which a pitcher is presumed to appear in an image that represents a pitching scene.

The processor detects an edge pixel from a difference image that represents a difference between a first image at a first time and a second image at a second time that are included in a video, and identifies an edge area in which a plurality of edge pixels are aligned in a prescribed direction in the difference image.

Then, the processor determines that the difference image represents the pitching scene on the basis of a size of the edge area included in the pitcher area indicated by the area information in the difference image and on the basis of a size of the edge area included in a prescribed area in the difference image.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a functional configuration of an image processing device;

FIG. 2 is a flowchart of image processing;

FIG. 3 illustrates a functional configuration of a specific example of the image processing device;

FIGS. 4A and 4B illustrate a pitcher area and a batter area;

FIG. 5 is a flowchart that illustrates a first specific example of the image processing;

FIGS. 6A to 6C illustrates difference images;

FIGS. 7A to 7D are diagrams that illustrate edge area generating processing;

FIG. 8 is a flowchart of determination processing;

FIG. 9 is a flowchart of first selecting processing;

FIG. 10 is a flowchart of second selecting processing;

FIG. 11 is a flowchart that illustrates a second specific example of the image processing;

FIG. 12 illustrates batter's box information; and

FIG. 13 illustrates a configuration of an information processing device.

### DESCRIPTION OF EMBODIMENTS

Embodiments will now be described in detail with reference to the drawings.

Viewers of a baseball game may wish to watch a specific scene included in videos. For example, when a fan of a certain player wants to watch all of the at-bat scenes of the player, it will be possible to cue and play back an at-bat scene if it is possible to acquire information indicating a time at which pitching is started for a player at bat. Further, people in a baseball team may wish to see a pitching motion of a specific pitcher continuously or to see a swing of a specific batter continuously when they prepare for the players of their competitor.

In this case, it is preferable that time information be acquired that indicates a point at which a pitcher has started pitching. In a baseball game broadcast nowadays, a score book in which information such as pitching is recorded is created, but a start time of pitching is not recorded in it. The reason is that a recording of a start time of pitching for every pitching without any errors or delays imposes a very heavy burden on a recorder. The start time of pitching may be recorded in a score book if the number of recorders is increased, although it is not always possible to secure a sufficient number of recorders. Thus, a technology is desired that analyzes a video so as to acquire information indicating a start time of pitching.

There is also an approach that detects cuts that are a break in a video and selects a cut corresponding to a start of pitching. A camera angle in a pitching scene is almost always the same in a baseball game broadcast, in which its video is often captured from the diagonally right rear of a pitcher and a video captured at another camera angle is also often inserted before a start of pitching. Thus, it is determined whether an image of the detected cut represents a pitching scene by estimating a camera angle, and a start time of a video that represents a pitching scene can be used as a start time of pitching.

However, there may be a video which does not have a cut before a start of pitching. For example, pitch intervals are controlled in major league games in order to shorten a game time, and there are many pitchers who throw a ball at short intervals. If a pitcher throws a ball at short intervals, there will not be a sufficient time to insert a video captured at another camera angle. Also in professional baseball games in Japan, there have been attempts to reduce a game time, so there is a possibility that there will be an increase in the number of videos which do not have a cut before a start of pitching, as in the major league. If there is not a cut before a start of pitching, it will be difficult to detect a start time of pitching on the basis of a cut.

This problem occurs not only when an image that represents a pitching scene is extracted from a video of a baseball game but also when the image is extracted from another video that includes a pitching motion.

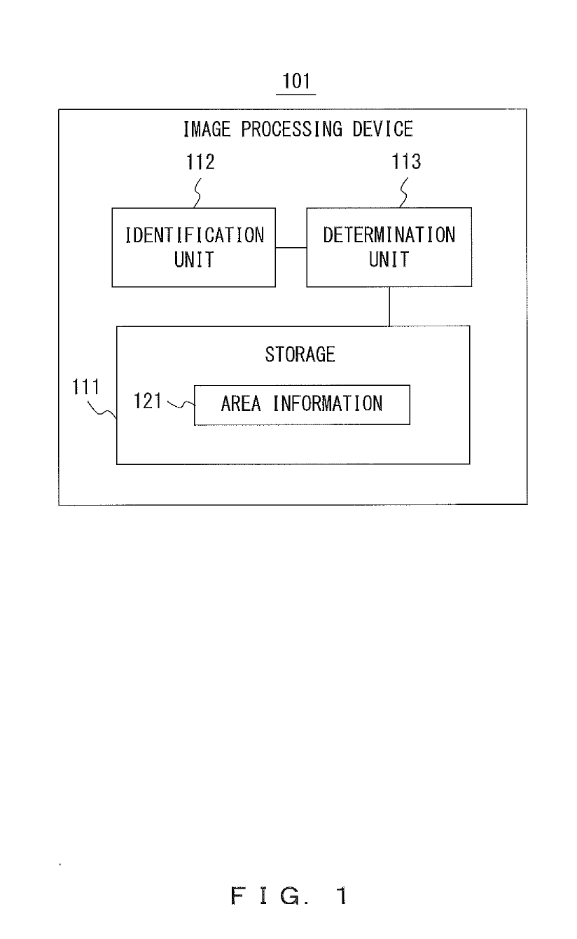

FIG. 1 illustrates an example of a functional configuration of an image processing device according to the embodiments. An image processing device 101 of FIG. 1 includes a storage 111, an identification unit 112, and a determination unit 113. The storage 111 stores area information 121 that indicates a pitcher area in which a pitcher is presumed to appear in an image that represents a pitching scene. The identification unit 112 performs prescribed processing using a video, and the determination unit 113 performs prescribed processing using the area information 121.

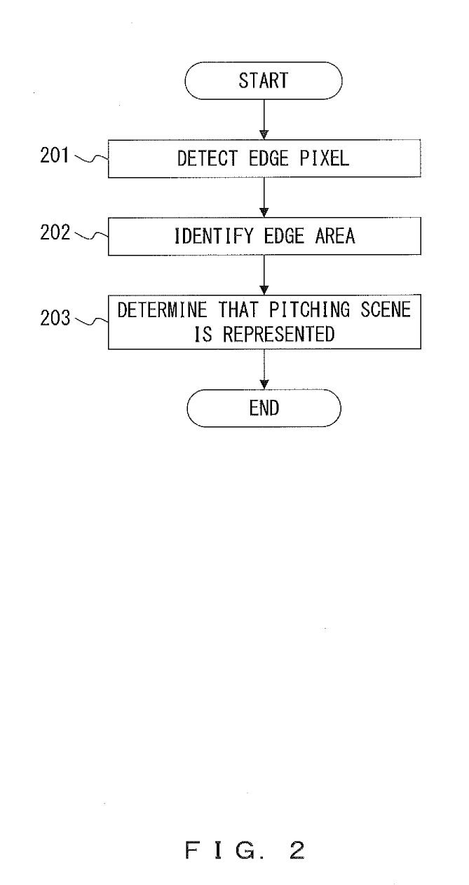

FIG. 2 is a flowchart that illustrates an example of image processing performed by the image processing device 101 of FIG. 1. First, the identification unit 112 detects an edge pixel from a difference image that represents a difference between a first image at a first time and a second image at a second time that are included in a video (Step 201). Next, the identification unit 112 identifies an edge area in which a plurality of edge pixels are aligned in a prescribed direction in the difference image (Step 202).

Next, the determination unit 113 determines that the difference image represents a pitching scene on the basis of the size of an edge area included in a pitcher area indicated by the area information 121 in the difference image and on the basis of the size of an edge area included in a prescribed area in the difference image (Step 203).

The image processing device 101 described above permits an identification of an image that represents a pitching scene in a video.

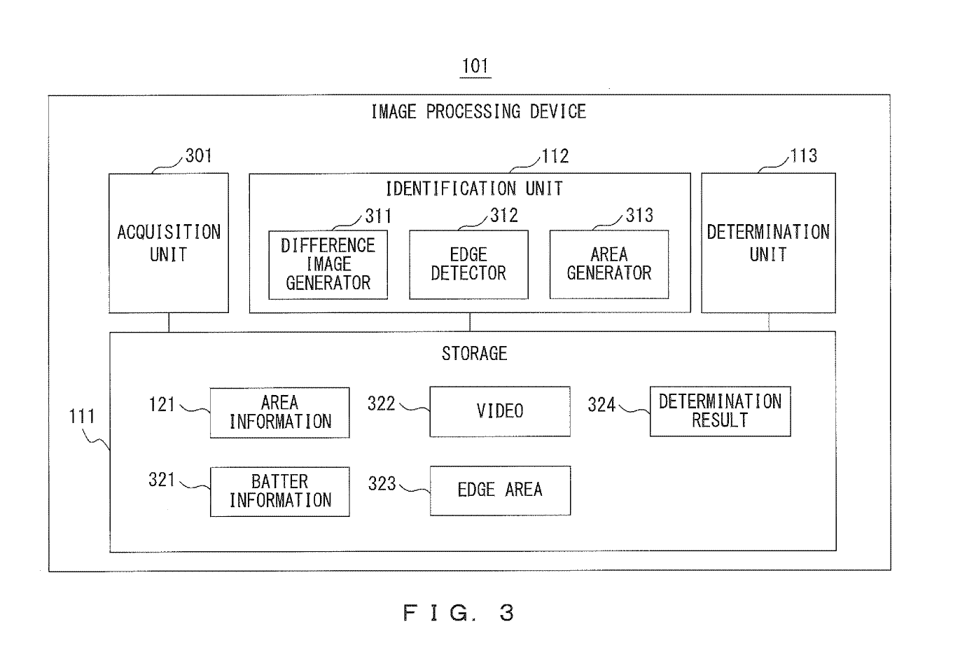

FIG. 3 illustrates a specific example of the image processing device 101 of FIG. 1. The image processing device 101 of FIG. 3 includes the storage 111, the identification unit 112, the determination unit 113, and an acquisition unit 301. The identification unit 112 includes a difference image generator 311, an edge detector 312, and an area generator 313.

The storage 111 stores the area information 121 and a video 322. The area information 121 indicates the pitcher area and a batter area in which a batter is presumed to appear in the image that represents the pitching scene.

The video 322 includes a plurality of images at a plurality of times, and the image at each time may be referred to as a frame. Each image may be a color image or a monochrome image. When the image is a color image, the pixel value may be in the RGB format or in the YUV format.

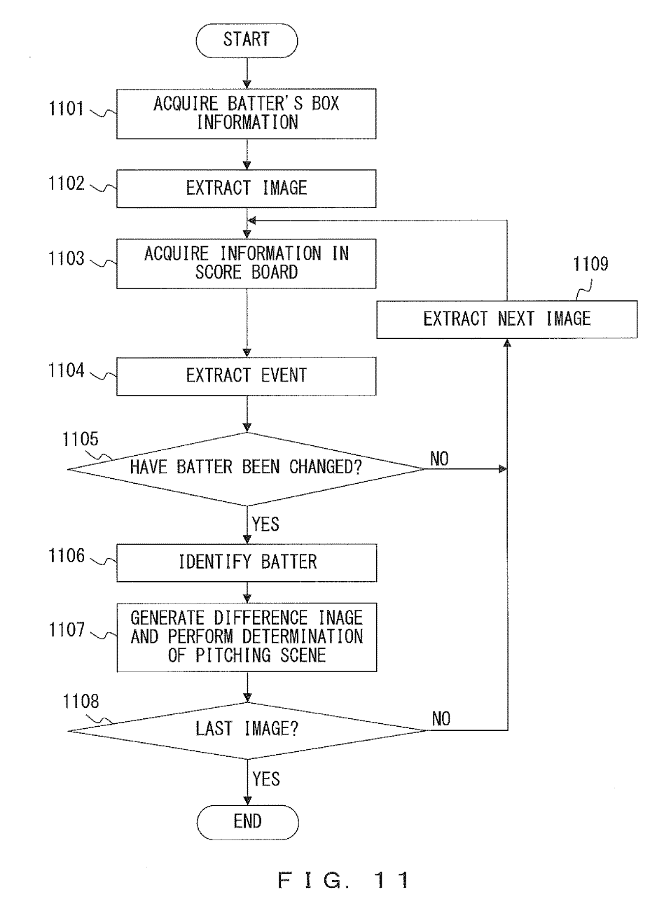

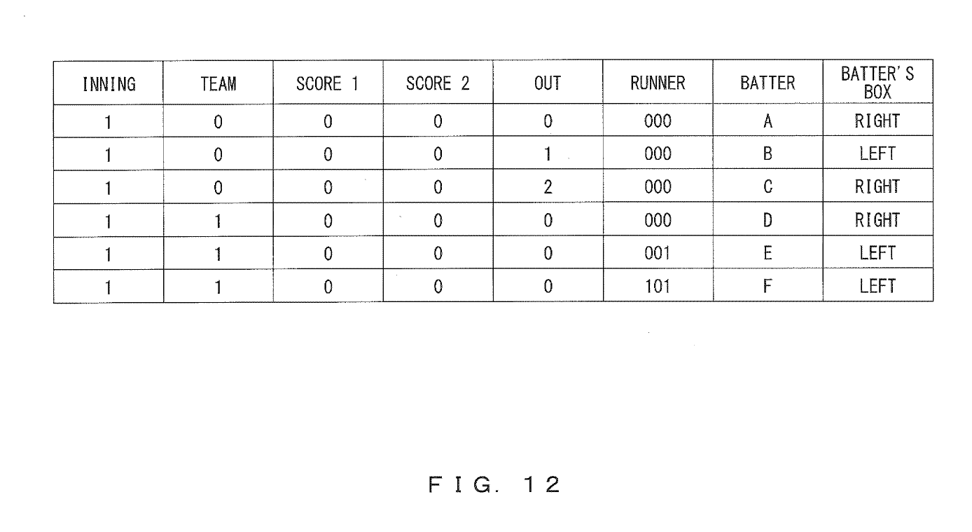

The acquisition unit 301 acquires batter information 321 indicating whether a batter is a right-handed batter or a left-handed batter in the pitching scene, and stores the batter information 321 in the storage 111. In a baseball game relay broadcast, members of each team are presented at the start of the game, and the game is recorded in a score book. The acquisition unit 301 can acquire, from this score book, batter's box information indicating whether the batter's box at which a batter stood is the right-handed-batter's box or the left-handed-batter's box for each inning and generate the batter information 321 from the batter's box information. A method for generating the batter information 321 will be described later with reference to FIGS. 11 and 12.

In order to detect a moving object from the video 322, the difference image generator 311 generates a difference image that represents a difference between two images at two times, the two images being included in the video 322. The difference image generated from the two images in the pitching scene includes a difference pixel value that represents a movement of, for example, a pitcher, a batter, a catcher, or an umpire on the field at a baseball stadium. For example, when a camera has been moved, the difference image may include a difference pixel value that represents, for example, a movement of the first base line or the third base line on the field, or a movement of the boundary of the field and the backstop or the boundary of the field and the fence.

The edge detector 312 calculates a difference in pixel value in a difference image so as to detect an edge pixel. The area generator 313 generates an edge area 323 that represents a portion in which a plurality of edge pixels are aligned in a prescribed direction in the difference image, and stores the edge area 323 in the storage 111.

In a difference image of a pitching scene, a movement in the background such as that of the first base line, the third base line, the boundary of the field and the backstop, or the boundary of the field and the fence appears as an edge pixel in a horizontal direction. On the other hand, a pitcher stands on the field, so a movement of the body of the pitcher appears as an edge pixel in a vertical direction.

Thus, the area generator 313 can use the vertical direction of an image as the prescribed direction in order to detect a movement of a pitcher without detecting any movement in the background. In this case, an angle formed by a direction perpendicular to the ground of the field and the vertical direction of the image is less than a prescribed angle, and an area determined by a portion in which edge pixels are aligned in the vertical direction is extracted as the edge area 323. It is possible to use, as the edge area 323, an area in which a plurality of continuations of edge pixels in the vertical direction are situated closely to one another.

Using the edge area 323 generated by the area generator 313 and the area information 121, the determination unit 113 determines whether a difference image represents a pitching scene. When the difference image represents a pitching scene, the determination unit 113 generates a determination result 324 indicating that images used to generate the difference image represent a pitching scene, and stores the determination result 324 in the storage 111. The determination unit 113 can determine that a difference image represents a pitching scene, for example, when the following conditions are satisfied.

(a) The size of an edge area 323 included in a pitcher area in the difference image is larger than a first threshold, the pitcher area being indicated by the area information 121. [0045] (b) The size of an edge area 323 included in a prescribed area in the difference image is equal to or smaller than a second threshold.

In this case, the determination unit 113 uses, as the prescribed area in (b) above, a remaining area obtained by removing the pitcher area and a batter area that are indicated by the area information 121 from the image that represents a pitching scene.

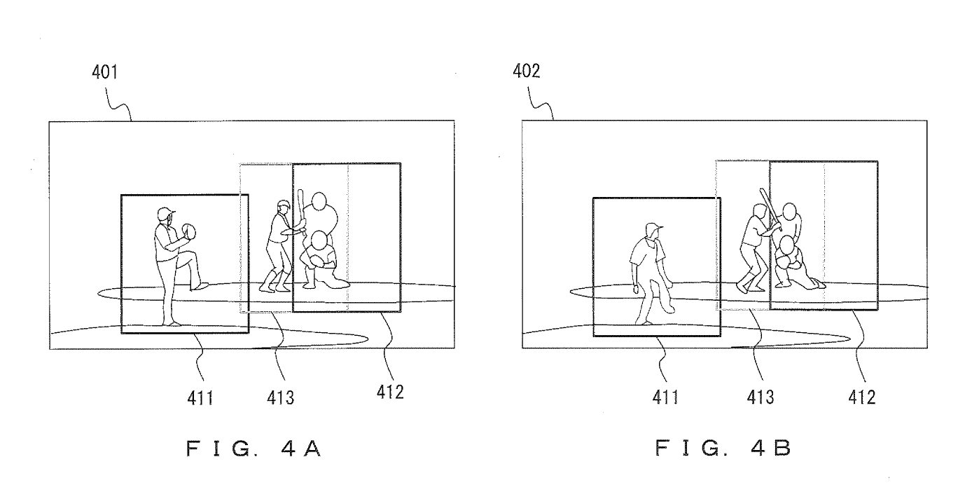

FIGS. 4A and 4B illustrate examples of pitcher areas and batter areas in images that represent a pitching scene. A pitcher who has started a pitching motion on the mound, a batter who is standing at the left batter's box, and a catcher and an umpire who are situated behind the batter appear in an image 401 illustrated in FIG. 4A.

In this case, the area information 121 includes information that indicates a pitcher area 411, a right-handed-batter area 412, and a left-handed-batter area 413. The right-handed batter is a batter who bats right, and the left-handed batter is a batter who bats left. The pitcher area 411 is an area in which a pitcher is presumed to appear, the right-handed-batter area 412 is an area in which a right-handed batter is presumed to appear, and the left-handed-batter area 413 is an area in which a left-handed batter is presumed to appear.

In a pitching scene, the video 322 is often captured from the diagonally upward right of a pitcher, so the body of the pitcher appears in a position slightly lowered on the left side in the image 401. For example, an underhanded pitcher may put his arm out to the side, but in this case, the movement of his arm appears as an edge pixel in the horizontal direction. Thus, in image processing in which a movement of a pitcher is detected on the basis of edge pixels in the vertical direction, it is not a problem if the case in which the pitcher is putting his arm out to the side is not taken into consideration. Therefore, the pitcher area 411 is set in the position slightly lowered on the left side in the image 401.

The batter appears in a position on the right side of the pitcher, so the right-handed-batter area 412 and the left-handed-batter area 413 are set in positions slightly to the right in the image 401. The right-handed-batter area 412 and the left-handed-batter area 413 also include an area in which the catcher and the umpire are presumed to appear.

When the batter information 321 indicates a right-handed batter, the determination unit 113 obtains the prescribed area in (b) above using the right-handed-batter area 412 as a batter area, and when the batter information 321 indicates a left-handed batter, the determination unit 113 obtains the prescribed area in (b) above using the left-handed-batter area 413 as the batter area.

In an image 402 illustrated in FIG. 4B, the pitcher who appears in the pitcher area 411 has moved broadly, and the batter, the catcher, and the umpire who appear in the left-handed-batter area 413 have also moved a little. However, there does not appear any moving object in a remaining area obtained by removing the pitcher area 411 and the left-handed-batter area 413 from the image 402. Thus, a difference image is more likely to represent a pitching scene when the size of an edge area 323 in the pitcher area 411 is larger than the first threshold and when the size of an edge area 323 in the remaining area obtained by removing the pitcher area 411 and the left-handed-batter area 413 is equal to or smaller than the second threshold.

The image processing device 101 of FIG. 3 makes it possible to extract an image that represents a pitching scene from the video 322 on the basis of the edge area 323 and the area information 121 even when there is not a cut before a start of pitching. Further, determinations of a start time of pitching and a pitching scene are performed at the same time, so it is possible to detect the pitching scene quickly and accurately.

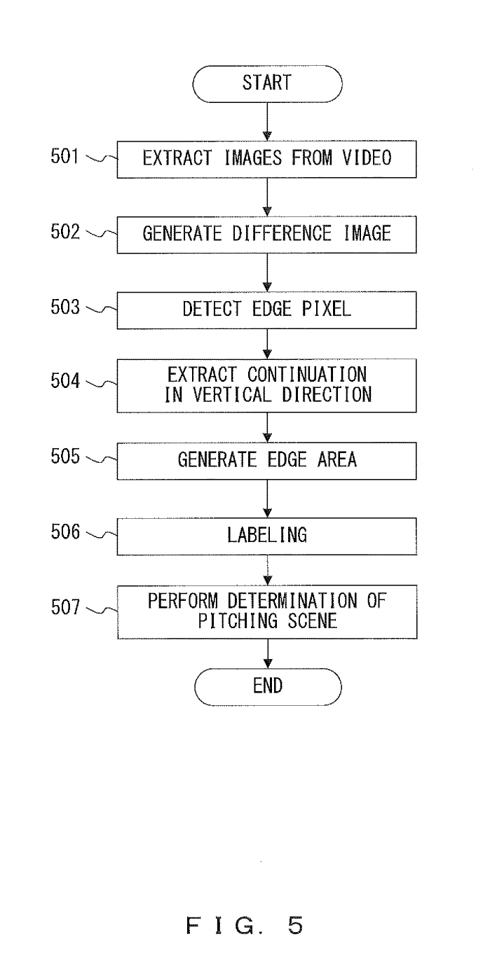

FIG. 5 is a flowchart that illustrates a first specific example of image processing performed by the image processing device 101 of FIG. 3. First, the difference image generator 311 extracts two images at two times from the video 322 (Step 501), and generates a difference image that represents a difference between these images (Step 502).

In an image at each time that is included in the video 322, an xy coordinate system is defined that has an x-axis in the horizontal direction and a y-axis in the vertical direction, wherein a pixel value at a coordinate (x,y) in an ith image (i is an integer not less than one) is pᵢ(x,y). In this case, a difference pixel value Dᵢ(x,y) of two consecutive images at two times is represented by the following formula:

Dᵢ(x,y)=|pᵢ₊₁(x,y)−pᵢ(x,y)| (1)

The difference image generator 311 generates the difference image whose pixel value at the coordinate (x,y) is Dᵢ(x,y) in Formula (1). For example, when a frame rate is high, the difference image generator 311 may generate a difference image of two images at two times that have one or more images between themselves. In order to simplify the descriptions, the pixel value Dᵢ(x,y) of the ith difference image may hereinafter be simply referred to as D(x,y).

Next, the edge detector 312 detects an edge pixel by calculating a difference Pe(x,y) of a pixel value in the horizontal direction in the difference image (Step 503). For example, Pe(x,y) is calculated using the following formula:

Pe(x,y)=D(x,y)−min[x−d1≦a≦x+d1](D(a,y)) (2)

d1 in Formula (2) represents the number of pixels in the horizontal direction, and min[x−d1≦a≦x+d1] (D(a,y)) represents a minimum value of D(a,y) when a variable “a” is varied in the range of x−d1≦a≦x+d1. For example, when d1=1, a difference between the minimum value among D(x−1,y), D(x,y), and D(x+1,y), and D(x,y) is obtained as Pe(x,y).

In a difference image, Pe(x,y) is zero in an area in which a pixel value does not vary significantly in the horizontal direction, and Pe(x,y) has a value other than zero at a position at which the pixel value varies significantly in the horizontal direction. In this case, a pixel whose Pe(x,y) has a value other than zero is detected as an edge pixel.

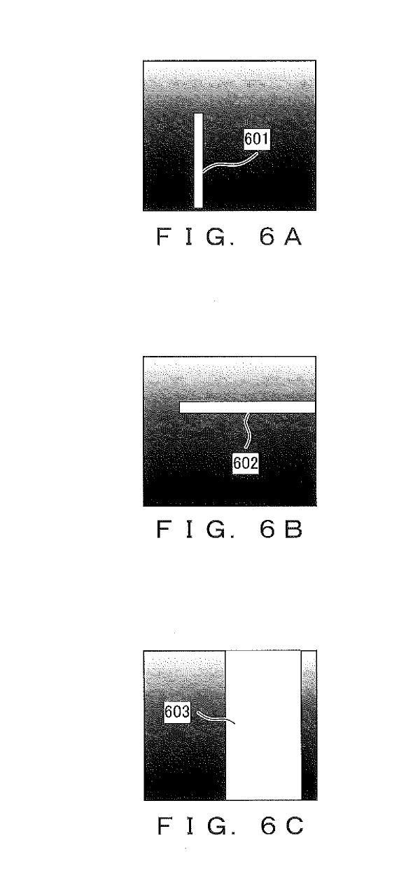

FIGS. 6A to 6C illustrates examples of difference images. A difference image illustrated in FIG. 6A includes a vertically long area 601 whose D(x,y) has a value other than zero. The area 601 appears when a vertically long object such as a pitcher has moved quickly in the horizontal direction.

A difference image illustrated in FIG. 6B includes a horizontally long area 602 whose D(x,y) has a value other than zero. The area 602 appears when a horizontally long object such as a boundary of a field and a backstop has moved in the vertical direction.

A difference image illustrated in FIG. 6C includes an area 603 that is crowded with pixels whose D(x,y) has a value other than zero. The area 603 appears when an object such as a backstop has moved.

The use of Pe(x,y) in Formula (2) makes it easy to detect an area, such as the area 601, in which pixel values D(x,y) that are not zero are continued in the vertical direction, and makes it difficult to detect the areas 602 and 603. This results in being able to detect a movement of a pitcher without detecting any movement in the background.

The edge detector 312 can also calculate Pe (x,y) using a morphological operation instead of Formula (2). For example, the morphological operation for the pixel value D(x,y) is represented by the following formula:

Dilatation(D(x,y),R)=min[(a,b)εR](D(a,b)) (3)

Erosion(D(x,y),R)=max[(a,b)εR](D(a,b)) (4)

Open(D(x,y),R)=Dilatation(Erosion(D(x,y),R),R) (5)

Close(D(x,y),R)=Erosion(Dilatation(D(x,y),R),R) (6)

TopHat(D(x,y),R)=D(x,y)−Open(D(x,y),R) (7)

In Formula (3), Dilatation(D(x,y),R) represents a dilatation operation, and R represents a prescribed area whose reference is a coordinate (x,y). min[(a,b)εR] (D(a,b)) represents a minimum value of D(a,b) when a coordinate (a,b) is varied in the area R. For example, when (a,b) is varied in a range that includes each one pixel situated at the left, right, top, and bottom of (x,y), the range of the area R is represented by x−1≦a≦x+1 and y−1≦b≦y+1.

In Formula (4), Erosion(D(x,y),R) represents an erosion operation, and max[(a,b)εR](D(a,b)) represents a maximum value of D(a,b) when the coordinate (a,b) is varied in the area R.

Open(D(x,y),R) in Formula (5) represents an opening operation in which the dilatation operation is performed after the erosion operation in the area R, and Close(D(x,y),R) in Formula (6) represents a closing operation in which the erosion operation is performed after the dilatation operation in the area R.

TopHat(D(x,y),R) in Formula (7) represents a top hat operation in which Open(D(x,y),R) is subtracted from D(x,y). In the top hat operation, first, a small pixel value in the area R is obtained as a reference value by performing the dilatation operation after the erosion operation, and a difference between the reference value and an original pixel value is then obtained by subtracting the reference value from the original pixel value. Pe (x,y) can be calculated by use of this top hat operation, using the following formula:

Pe(x,y)=TopHat(D(x,y),Re) (8)

Pe(x,y) represents a difference in pixel value in the horizontal direction, so a horizontally long area is used as an area Re in Formula (8). For example, the range of the area Re may be the range of x−k≦a≦x+k and b=y which is represented by use of an integer k not less than one.

Next, the area generator 313 extracts, as a continuation in the vertical direction, a portion in which a plurality of edge pixels are aligned in the vertical direction (Step 504). An indicator Pv(x,y) that indicates how edge pixels are continued in the vertical direction at a coordinate (x,y) is calculated using the following formula:

Pv(x,y)=min[y−d2≦b≦y+d2](Pe(x,b)) (9)

d2 in Formula (9) represents the number of pixels in the vertical direction, and min[y−d2≦b≦y+d2] (Pe(x,b)) represents a minimum value of Pe(x,b) when a variable “b” is varied in the range of y−d2≦b≦y+d2.

When all of the differences Pe(x,b) in the range of y−d2≦b≦y+d2 have values other than zero and represent edge pixels, Pv (x,y) also has a value other than zero. On the other hand, when one of the differences Pe(x,b) in the range is zero and a pixel that is not an edge pixel is included, Pv(x,y) is zero. Thus, a pixel whose Pv(x,y) has a value other than zero is extracted as a pixel that belongs to a continuation of edge pixels in the vertical direction.

However, when Formula (9) is used, Pv(x,y) will become zero if there is just one missing edge pixel in the range of y−d2≦b≦y+d2, with the result that a continuation in the vertical direction is not extracted. Thus, instead of the minimum value of Pe(x,b), an nth smallest value (n is an integer not less than two) may be used as Pv(x,y).

The area generator 313 can calculate Pv(x,y) using the following formula instead of Formula (9):

Pv(x,y)=Close(Pe(x,y),Rv) (10)

In the closing operation in Formula (10), the erosion operation is performed after the dilatation operation in a range Rv, so a larger value of Pe(x,y) in the area Rv is obtained as Pv(x,y). Thus, Pv(x,y) will never become zero even if there are a certain number of missing edge pixels in the area Rv, with the result that a continuation in the vertical direction can be extracted.

A vertically long area is used as the area Rv in Formula (10) in order to extract a continuation in the vertical direction. For example, the range of the area Rv may be the range of a=x and y−k≦b≦y+k which is represented by use of the integer k not less than one. The value of k can be changed according to the size of an image, and may be, for example, k=3.

Next, the area generator 313 generates the edge area 323 using Pv(x,y) (Step 505). An indicator PL(x,y) that indicates how a plurality of continuations in the vertical direction are situated closely to one another at a coordinate (x,y) is calculated, for example, using the following formula:

PL(x,y)=Median[(a,b)εRL](Pv(a,b)) (11)

The range of an area RL in Formula (11) is the range of x−d3≦a≦x+d3 and y−d4≦b≦y+d4, and d3 and d4 represent the numbers of pixels in the horizontal direction and in the vertical direction, respectively. Median[(a,b)εERL](Pv(a,b)) represents the median of Pv(a,b) when the coordinate (a,b) is varied in the area RL. In order to extract a continuation in the vertical direction in a somewhat broad range, values greater than d2 are preferably used as d3 and d4. For example, they may be d3=d4=15. The values of d3 and d4 can be changed according to the size of an image.

When the median is obtained, the median in a partial area that is, for example, one third of the area RL may be used instead of using an exact median in the area RL. Further, the average of Pv(a,b) may be used instead of using the median of Pv(a,b).

PL(x,y) is closer to zero if there are a larger number of pixels with Pv(a,b)=0 in the area RL, and PL(x,y) is larger if there are a larger number of pixels with Pv(a,b)≠0. In this case, the area generator 313 extracts, as a pixel of the edge area 323, a pixel in which PL(x,y) is not less than a prescribed threshold TL. For example, the area generator 313 binarizes PL(x,y) by use of the threshold TL using the following formula, so as to generate a binary image:

PB(x,y)=1(PL(x,y)≧TL) (12)

PB(x,y)=0(PL(x,y)<TL) (13)

PB(x,y) in Formula (12) and Formula (13) represents a pixel value of the generated binary image, and an area in which pixels with PB(x,y)=1 are distributed represents the edge area 323 in which a plurality of continuations in the vertical direction are situated closely to one another.

The area generator 313 can also calculate PL(x,y) using the following formula instead of Formula (11):

PL(x,y)=Close(Pv(x,y),RL) (14)

Next, the area generator 313 performs labeling processing on the binary image, and extracts the edge area 323 (Step 506). This labeling processing is processing of obtaining an area in which pixels with PB (x,y)=1 are concatenated in the binary image, and is performed by, for example, the following procedure.

(1) The area generator 313 keeps, in the storage 111, an area in which label numbers whose number is equal to the number of pixels in the binary image are associated with coordinates of the respective pixels and recorded, and sets zero to each of the label numbers. The pixel whose label number is zero corresponds to a pixel that has not been labeled yet. Then, the area generator 313 sets zero to a variable LN that represents a label number.

(2) The area generator 313 scans the binary image from a pixel on the upper left sequentially, and when a pixel with PB(x,y)=1 is found, the area generator 313 checks a label number corresponding to the found pixel.

(3) When the label number of the found pixel is zero, the area generator 313 increments LN by one.

(4) The area generator 313 searches pixels in the left, right, top and bottom directions from the found pixel, and obtains a concatenation area in which pixels with PB (x,y)=1 are concatenated. Then, the area generator 313 rewrites the label numbers of all of the pixels in the obtained concatenation area with a value represented by LN.

(5) The area generator 313 repeats the processes of (2) to (4) above until the label numbers of all of the pixels in the binary image are rewritten.

The labeling processing described above gives different label numbers to one or more edge areas 323 in a difference image, and determines pixels included in each of the edge areas 323. A different procedure than the procedure of (1) to (5) above may be used in order to speed up labeling processing.

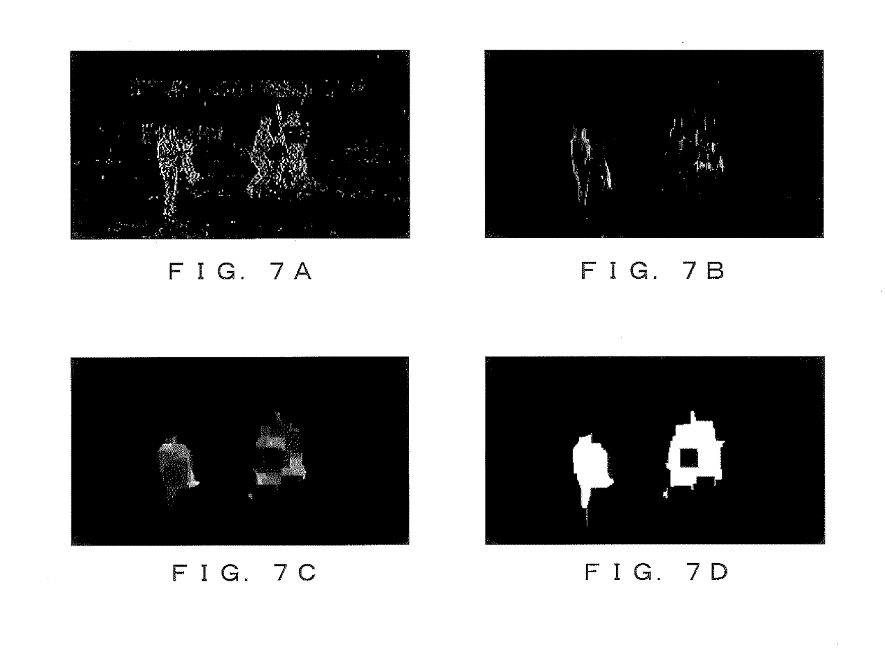

FIGS. 7A to 7D are diagrams that illustrate examples of edge area generating processing. FIG. 7A illustrates a distribution of Pe(x,y), a difference in pixel value in a difference image generated from the image 401 of FIG. 4A, and FIG. 7B illustrates a distribution of Pv(x,y), an indicator that indicates a continuation in the vertical direction that is calculated from Pe(x,y).

FIG. 7C illustrates a distribution of PL(x,y), an indicator that indicates the edge area 323 calculated from Pv(x,y), and FIG. 7D indicates a binary image obtained by binarizing PL(x,y). In the binary image of FIG. 7D, an edge area 323 that represents the body of the pitcher is generated in the pitcher area 411, and an edge area 323 that represents the bodies of the batter, the catcher, and the umpire are generated in the left-handed-batter area 413.

Next, the determination unit 113 determines whether the difference image represents a pitching scene by assessing the size of the edge area 323 included in the pitcher area in the difference image and the size of the edge area 323 included in the prescribed area (Step 507).

As the size of each of the edge areas 323, the length of the edge area 323 in the horizontal direction or the vertical direction, or the area of the edge area 323 can be used. The length of the edge area 323 in the horizontal direction is represented by the difference between the maximum value and the minimum value of x coordinates of pixels that have the label number of the edge area 323. The length of the edge area 323 in the vertical direction is represented by the difference between the maximum value and the minimum value of y coordinates of the pixels that have the label number of the edge area 323. The area of the edge area 323 is represented by a total number of pixels that each have the label number of the edge area 323.

An edge area 323 that is smaller than a prescribed value is more likely to represent noise, so the determination unit 113 may exclude such an edge area 323 from being a target to be processed.

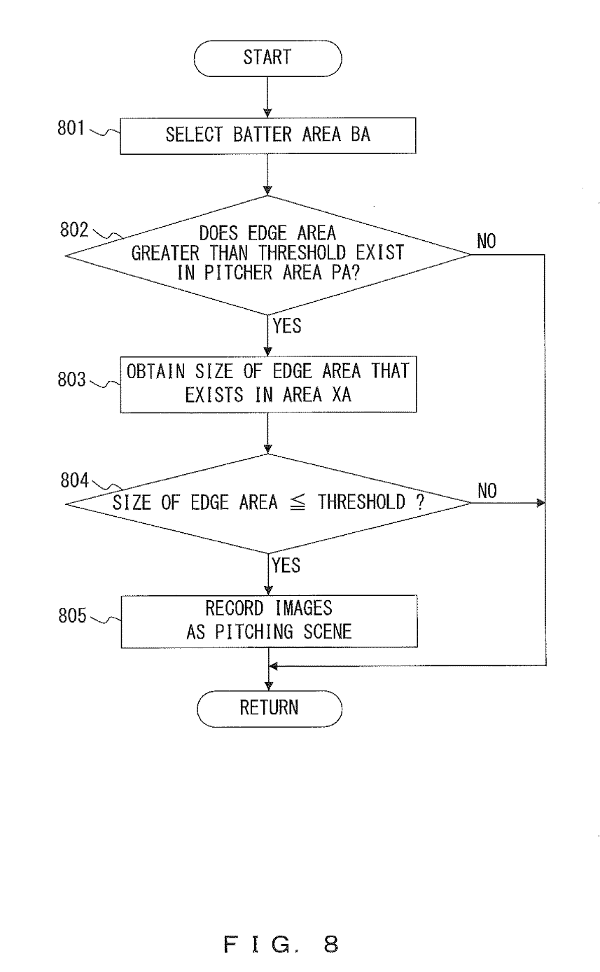

FIG. 8 is a flowchart that illustrates an example of determination processing in Step 507 of FIG. 5. First, the determination unit 113 selects a right-handed-batter area or a left-handed-batter area indicated by the area information 121 to be a batter area BA (Step 801). Then, the determination unit 113 checks whether an edge area 323 that is greater than a threshold exists in a pitcher area PA indicated by the area information 121 (Step 802).

For example, when the area of an edge area 323 is used as its size, the determination unit 113 calculates a total number of pixels Pcount in an edge area 323 using the following formula:

$$Pcount = {\sum }_{( x , y ) ∈ PA} PB ( x , y ) \qquad ( 21 )$$

Then, the determination unit 113 determines that the edge area 323 greater than the threshold exists in the pitcher area PA when Pcount is greater than a threshold TP, and determines that the edge area 323 greater than the threshold does not exist in the pitcher area PA when Pcount is not greater than TP.

When the edge area 323 greater than the threshold exists in the pitcher area PA (Step 802, YES), the determination unit 113 obtains the size of an edge area 323 that exists in a remaining area XA obtained by removing the pitcher area PA and the batter area BA from the difference image (Step 803). Then, the determination unit 113 compares the size of the obtained edge area 323 with a threshold (Step 804).

For example, the determination unit 113 calculates a total number of pixels Xcount in the edge area 323 that exists in the area XA, using the following formula:

$$Xcount = {\sum }_{( x , y ) ∈ XA} PB ( x , y ) \qquad ( 22 )$$

Then, the determination unit 113 determines that the size of the obtained edge area 323 is greater than the threshold when Xcount is greater than a threshold TX, and determines that the size of the obtained edge area 323 is not greater than the threshold when Xcount is not greater than TX. When noise is less likely to be included because an edge area 323 that is less than the prescribed value has been excluded from a target to be processed, a small integer can be used as TX. In this case, the threshold TX may be 0.

When the size of the obtained edge area 323 is not greater than the threshold (Step 804, YES), the determination unit 113 determines that the difference image represents a pitching scene. Then, the determination unit 113 records the images used to generate the difference image in the determination result 324 as a pitching scene (Step 805).

When the edge area 323 greater than the threshold does not exist in the pitcher area PA (Step 802, NO), the determination unit 113 determines that the difference image does not represent a pitching scene, and terminates the processing. When the size of the edge area 323 in the area XA is greater than the threshold (Step 804, NO), the determination unit 113 determines that the difference image does not represent a pitching scene, and terminates the processing.

In Step 802, the determination unit 113 can also set an upper limit and a lower limit of the size of the edge area 323 and use a condition in which the size of the edge area 323 is not greater than the upper limit and is greater than the lower limit. In this case, the determination unit 113 checks whether an edge area 323 that satisfies the condition exists in the pitcher area PA. This makes it possible to prevent an oversized edge area 323 from being falsely determined to be a pitcher when a relatively broad area has been set as the pitcher area PA and when the presumption that the body of the pitcher appears in the entirety of the pitcher area PA does not seem natural.

The image processing device 101 determines whether an image at each time included in the video 322 represents a pitching scene by repeatedly performing the image processing of FIG. 5 on each image.

In a pitching scene, it is often the case that several similar difference images are consecutively generated. Thus, in order to improve a determination accuracy, the determination unit 113 may generate the determination result 324 on the basis of results of determinations of several consecutive difference images. In this case, when the results of determinations of the several difference images represent a pitching scene, the determination unit 113 records the images used to generate these difference images in the determination result 324 as a pitching scene. The determination unit 113 may record the used images in the determination result 324 not only when several consecutive difference images have been determined to be a pitching scene, but also when some of the several consecutive difference images (for example, three out of five) have been determined to be a pitching scene.

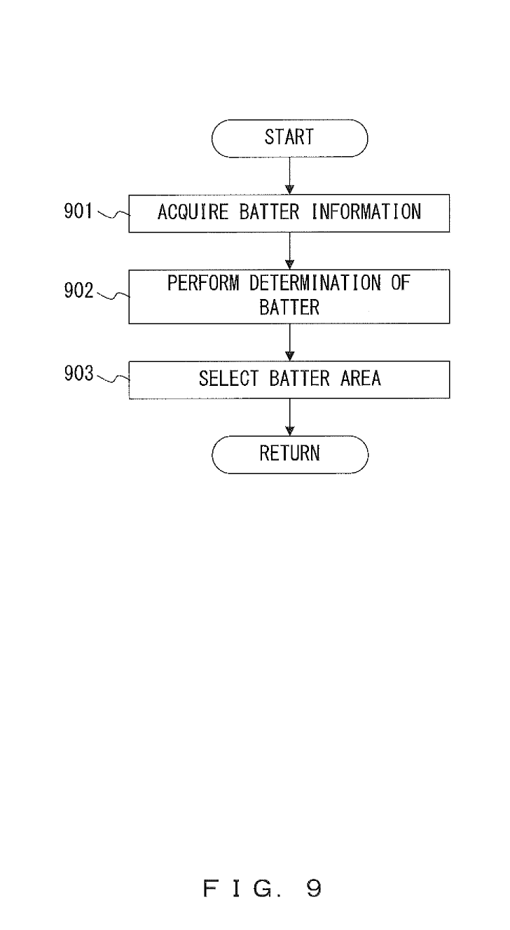

FIG. 9 is a flowchart that illustrates an example of first selecting processing in Step 801 of FIG. 8. First, the determination unit 113 acquires the batter information 321 from the storage 111 (Step 901), and determines whether a batter indicated by the batter information 321 is a right-handed batter or a left-handed batter (Step 902). Then, the determination unit 113 selects a right-handed-batter area or a left-handed-batter area indicated by the area information 121 as a batter area that corresponds to a determination result (Step 903).

According to the selecting processing of FIG. 9, it is possible to select an area in which a batter is more likely to appear in a difference image on the basis of the batter information 321 acquired by the acquisition unit 301.

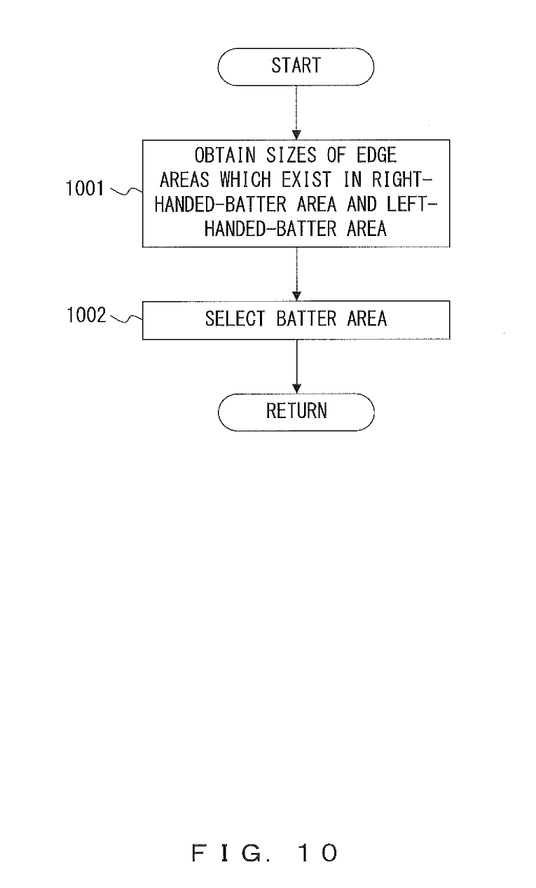

FIG. 10 is a flowchart that illustrates an example of second selecting processing in Step 801 of FIG. 8. First, the determination unit 113 obtains the size of an edge area 323 which exists in the right-handed-batter area indicated by the area information 121 and the size of an edge area 323 which exists in the left-handed-batter area indicated by the area information 121 (Step 1001). Then, from among the right-handed-batter area and the left-handed-batter area, the determination unit 113 selects an area that includes a larger edge area 323 as a batter area (Step 1002).

For example, when the area of an edge area 323 is used as its size, the determination unit 113 calculates a total number of pixels BRcount in an edge area 323 that exists in a right-handed-batter area BRA, using the following formula:

$$BRcount = {\sum }_{( x , y ) ∈ BRA} PB ( x , y ) \qquad ( 23 )$$

Further, the determination unit 113 calculates a total number of pixels BLcount in an edge area 323 that exists in a left-handed-batter area BLA, using the following formula:

$$BLcount = {\sum }_{( x , y ) ∈ BLA} PB ( x , y ) \qquad ( 24 )$$

Then, the determination unit 113 selects the right-handed-batter area BRA when BRcount is greater than BLcount, and selects the left-handed-batter area BLA when BLcount is greater than BRcount.

According to the selecting processing of FIG. 10, it is possible to select an area in which a batter is more likely to appear in a difference image without using the batter information 321. Thus, the acquisition unit 301 of FIG. 3 can be omitted when the selecting processing of FIG. 10 is used.

When the size of the right-handed-batter area BRA and the size of the left-handed-batter area BLA are different, the determination unit 113 may compare the ratio of BRcount to a total number of pixels in the right-handed-batter area BRA with the ratio of BLcount to a total number of pixels in the left-handed-batter area BLA.

In the example of FIG. 4, the right-handed-batter area 412 and the left-handed-batter area 413 are set, but it is also possible to set a single batter area obtained by integrating these areas. In this case, the determination unit 113 uses the set single batter area in Step 801 without any changes.

FIG. 11 is a flowchart that illustrates a second specific example of the image processing performed by the image processing device 101 of FIG. 3. This flowchart also includes processing of generating the batter information 321 from the batter's box information that is performed by the acquisition unit 301. First, the acquisition unit 301 acquires the batter's box information from the score book (Step 1101). Here, a user may input information of the score book to the image processing device 101.

FIG. 12 illustrates an example of batter's box information acquired from a score book. Batter's box information of FIG. 12 includes items of INNING, TEAM, SCORE 1, SCORE 2, OUT, RUNNER, BATTER, and BATTER'S BOX. SCORE 1 represents the score of a team of the top of an inning, SCORE 2 represents the score of a team of the bottom of an inning, and OUT represents the number of players who have been called out. RUNNER represents the presence or absence of a runner, BATTER represents a name of a batter, and BATTER'S BOX represents a batter's box at which a batter stood (a right-handed-batter's box or a left-handed-batter's box).

The presence or absence of a runner can be represented by a three-bit binary number in which the three bits respectively correspond to first base, second base, and third base. The first bit, the second bit, and the third bit respectively correspond to third base, second base, and first base, in which the bit value “1” represents that there is a runner and the bit value “0” represents that there is not a runner. For example, “000” represents that there are no runners on first to third bases, “111” represents that the bases are loaded, “100” represents that there is a runner only on third base, and “101” represents that there are runners on first and third bases.

FIG. 12 only illustrates information on the inning “1”, but batter's box information on all of the innings is acquired in Step 1101. However, information in the items of SCORE 1, SCORE 2, OUT, RUNNER, and BATTER is not always used, so it is not a problem if some of or all of these items are omitted.

Next, the acquisition unit 301 extracts an image at the first time from the video 322 (Step 1102), analyzes the image, and acquires information in a score board displayed on a screen (Step 1103).

In a baseball game broadcast, the score recorded during a game is displayed on a screen as a score board. However, it is often the case that the score in each inning is not immediately reflected in a score board on a screen, so there is a possibility that the score board will not be displayed for a long period of time. Thus, information in a score board is not suitable for a detection of a start time of pitching, but it can be used to detect a change in batter. It is conceivable that one of the following events will occur if batters have been changed during a game:

(E1) An inning or a team (top/bottom) is changed.

(E2) The score, the number of outs, or the number of runners is increased.

Thus, the acquisition unit 301 can detect a change in batter by extracting these events from the information in the score board included in the video 322. An area in which the score board is displayed on a screen is predetermined, so it is also possible to read the information in the score board using an optical character recognition (OCR) technology for an image of the area.

Further, the score or the like in a score board may be displayed by the number of prescribed symbols such as “∘”. In this case, it is possible to extract the information in the score board using a similar image search technology. For example, the acquisition unit 301 extracts an image of a display position of a symbol in the score board from the image extracted in Step 1102, and calculates a similarity between the extracted image and a template image that represents the symbol. Then, when the similarity is not less than a prescribed value, the acquisition unit 301 determines that the symbol is being displayed.

Here, the acquisition unit 301 can calculate the similarity using, for example, a color layout feature of an image as a feature. The color layout feature represents an average color in each small area when the image is divided into a plurality of small areas. Further, the acquisition unit 301 calculates a distance between two feature vectors that represent two images, and when the distance is not greater than the prescribed value, the acquisition unit 301 can also determine that the similarity is not less than the prescribed value.

Next, the acquisition unit 301 extracts an event from the acquired information in the score board (Step 1104), and determines whether batters have been changed on the basis of the extracted event (Step 1105). For example, when the event (E1) or (E2) above has been extracted, the acquisition unit 301 determines that the batters have been changed.

When the batters have been changed (Step 1105, YES), the acquisition unit 301 refers to the batter's box information acquired in Step 1101, and determines whether a next batter is a right-handed batter or a left-handed batter (Step 1106). Then, the acquisition unit 301 generates batter information 321 that indicates the determined batter.

Next, the image processing device 101 generates a difference image by performing processes similar to the processes of Step 502 to Step 507 of FIG. 5, and determines whether the difference image represents a pitching scene (Step 1107). Then, the acquisition unit 301 checks whether the last image included in the video 322 has been extracted (Step 1108).

When the last image has not been extracted (Step 1108, NO), the acquisition unit 301 extracts an image at a next time from the video 322 (Step 1109) and repeats the processes of and after Step 1103. When the batters have not been changed (Step 1105, NO), the acquisition unit 301 repeats the processes of and after Step 1109. When the last image has been extracted (Step 1108, YES), the acquisition unit 301 terminates the processing.

The information in the score board that is acquired in Step 1103 does not always match the batter's box information acquired from the score book in Step 1101. For example, when the number of outs in one information is smaller than the number of outs in the other information, there may be an out that has not been counted yet.

Thus, the acquisition unit 301 compares an event of, for example, the score, an out, or a runner that is extracted from the information in the score board with an event recorded in the batter's box information, and when they do not match, the acquisition unit 301 may correct one of the pieces of information in accordance with the other one. This prevents a decrease in the accuracy of the batter information 321 due to a false event being extracted or an event not being extracted.

In Step 1106, when an identified batter is a switch hitter, the acquisition unit 301 can determine whether the batter is a right-handed batter or a left-handed batter on the basis of the information indicating that a pitcher is right-handed or left-handed. It is assumed that the batter stands at the left-handed-batter's box when the pitcher is right-handed and the batter stands at the right-handed-batter's box when the pitcher is left-handed. Alternatively, the acquisition unit 301 may generate batter information 321 indicating that the batter is a switch hitter, and the determination unit 113 may use a batter area obtained by integrating a right-handed-batter area and a left-handed-batter area, on the basis of the batter information 321.

The batter information 321 used by the determination unit 113 to perform the processing in Step 901 of FIG. 9 is generated by the acquisition unit 301 before the image processing of FIG. 5 is started. A method for generating this batter information 321 is similar to the processes of Step 1101 to Step 1106.

The configuration of the image processing device 101 of FIGS. 1 and 3 is merely an example, and some of the components may be omitted or changed according to the applications or the requirements of the image processing device 101. For example, when the batter information 321 has been generated beforehand and stored in the storage 111, the acquisition unit 301 of FIG. 3 can be omitted. When a single batter area is set instead of the right-handed-batter area and the left-handed-batter area, or when the selection processing of FIG. 10 is selected, the acquisition unit 301 can also be omitted.

The flowcharts of FIGS. 2, 5, and 8 to 11 are merely examples, and some of the processes may be omitted or changed according to the configurations or the requirements of the image processing device 101. For example, when a single batter area is set instead of the right-handed-batter area and the left-handed-batter area, the process of Step 801 of FIG. 8 can be omitted.

The images, the pitcher areas, the right-handed-batter areas, and the left-handed-batter areas of FIGS. 4A and 4B, and the calculation results in FIGS. 7A to 7D are merely examples, and the image, the pitcher area, the right-handed-batter area, the left-handed-batter area, and the calculation result vary according to the video to be processed, or the configurations or the requirements of the image processing device 101. For example, the video 322 is not limited to a video of a baseball game, but it may be another video that includes a pitching motion. The pitcher area, the right-handed-batter area, and the left-handed-batter area may have a shape other than a rectangle.

The batter information of FIG. 12 is merely an example, and other batter information may be used according to the configurations or the requirements of the image processing device 101. Formulas (1) to (24) are merely examples, and other formulations may be used according to the configurations or the requirements of the image processing device 101.

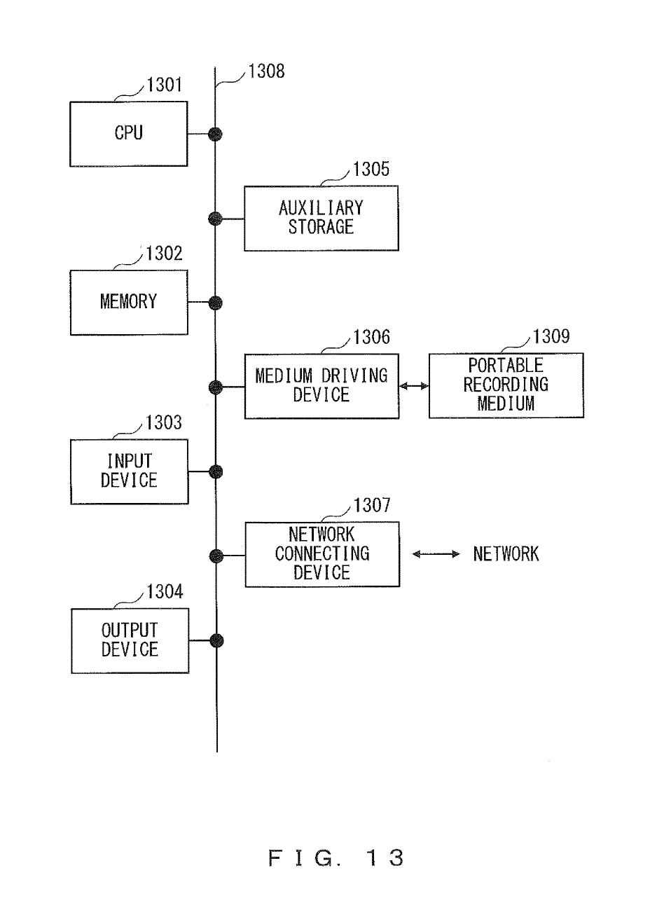

The image processing device 101 of FIGS. 1 and 3 may be implemented using, for example, an information processing device (a computer) illustrated in FIG. 13. The information processing device of FIG. 13 includes a central processing unit (CPU) 1301, a memory 1302, an input device 1303, an output device 1304, an auxiliary storage 1305, a medium driving device 1306, and a network connecting device 1307. These components are connected to one another via a bus 1308.

The memory 1302 is, for example, a semiconductor memory such as a read only memory (ROM), a random access memory (RAM), or a flash memory, and stores a program and data used for performing image processing. The memory 1302 can be used as the storage 111 of FIGS. 1 and 3.

For example, the CPU 1301 (a processor) operates as the identification unit 112, the determination unit 113, the acquisition unit 301, the difference image generator 311, the edge detector 312, and the area generator 313 of FIGS. 1 and 3 by executing the program by use of the memory 1302.

The input device 1303 is, for example, a keyboard or a pointing device, and is used for inputting instructions or information from a user or an operator. The output device 1304 is, for example, a display, a printer, or a speaker, and is used for outputting inquiries to the user or the operator or for outputting a result of processing. The result of processing may be the determination result 324 of FIG. 3.

The auxiliary storage 1305 is, for example, a magnetic disk device, an optical disk device, a magneto-optical disk device, or a tape device. The auxiliary storage 1305 may be a hard disk drive. The information processing device can store the program and the data in the auxiliary storage 1305 so as to load them into the memory 1302 and use them. The auxiliary storage 1305 can be used as the storage 111 of FIGS. 1 and 3.

The medium driving device 1306 drives a portable recording medium 1309 so as to access the recorded content. The portable recording medium 1309 is, for example, a memory device, a flexible disk, an optical disc, or a magneto-optical disk. The portable recording medium 1309 may be, for example, a compact disk read only memory (CD-ROM), a digital versatile disk (DVD), or a universal serial bus (USB) memory. The user or the operator can store the program and the data in the portable recording medium 1309 so as to load them into the memory 1302 and use them.

As described above, a computer-readable recording medium that stores therein a program and data used for performing image processing is a physical (non-transitory) recording medium such as the memory 1302, the auxiliary storage 1305, and the portable recording medium 1309.

The network connecting device 1307 is a communication interface that is connected to a communication network such as a local area network or a wide area network and makes a data conversion associated with communication. The information processing device can receive the program and the data from an external device via the network connecting device 1307 so as to load them into the memory 1302 and use them.

The information processing device can also receive the video 322 and a processing request from a user terminal and transmit the determination result 324 to the user terminal via the network connecting device 1307.

The information processing device does not necessarily include all of the components in FIG. 13, and some of the components can be omitted according to the applications or the requirements. For example, when the information processing device receives a processing request from the user terminal via the communication network, the input device 1303 and the output device 1304 may be omitted. When the portable recording medium 1309 or the communication network is not used, the medium driving device 1306 or the network connecting device 1307 may be omitted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing device comprising:
a memory that stores area information indicating a pitcher area in which a pitcher is presumed to appear in an image that represents a pitching scene; and
a processor coupled to the memory and that executes a process including
detecting an edge pixel from a difference image that represents a difference between a first image at a first time and a second image at a second time that are included in a video,
identifying an edge area in which a plurality of edge pixels are aligned in a prescribed direction in the difference image, and
determining that the difference image represents the pitching scene on the basis of a size of the edge area included in the pitcher area indicated by the area information in the difference image and on the basis of a size of the edge area included in a prescribed area in the difference image.

2. The image processing device according to claim 1, wherein
the area information further indicates a batter area in which a batter is presumed to appear in the image that represents the pitching scene,
an angle formed by a direction perpendicular to a ground in the pitching scene and the prescribed direction is less than a prescribed angle,
the prescribed area is a remaining area obtained by removing the pitcher area and the batter area from the image that represents the pitching scene, and
the processor determines that the difference image represents the pitching scene when the size of the edge area included in the pitcher area is larger than a first threshold and when the size of the edge area included in the prescribed area is equal to or smaller than a second threshold.

3. The image processing device according to claim 2, wherein
the batter area indicated by the area information includes a right-handed-batter area in which a right-handed batter is presumed to appear and a left-handed-batter area in which a left-handed batter is presumed to appear,
the processor acquires batter information that indicates whether the batter presumed to appear in the image is the right-handed batter or the left-handed batter in the pitching scene, and
the processor uses, as the prescribed area, a remaining area obtained by removing the pitcher area and the right-handed-batter area from the difference image when the batter information indicates the right-handed batter, and a remaining area obtained by removing the pitcher area and the left-handed-batter area from the difference image when the batter information indicates the left-handed batter.

4. The image processing device according to claim 2, wherein
the batter area indicated by the area information includes a right-handed-batter area in which a right-handed batter is presumed to appear and a left-handed-batter area in which a left-handed batter is presumed to appear, and
the processor uses, as the prescribed area, a remaining area obtained by removing the pitcher area and the right-handed-batter area from the difference image when a size of the edge area included in the right-handed-batter area is larger than a size of the edge area included in the left-handed-batter area in the difference image, and a remaining area obtained by removing the pitcher area and the left-handed-batter area from the difference image when the size of the edge area included in the left-handed-batter area is larger than the size of the edge area included in the right-handed-batter area.

5. A non-transitory computer-readable recording medium having stored therein an image processing program that causes a computer to execute a process comprising:
detecting an edge pixel from a difference image that represents a difference between a first image at a first time and a second image at a second time that are included in a video;
identifying an edge area in which a plurality of edge pixels are aligned in a prescribed direction in the difference image; and
referring to area information indicating a pitcher area in which a pitcher is presumed to appear in an image that represents a pitching scene, and determining that the difference image represents the pitching scene on the basis of a size of the edge area included in the pitcher area in the difference image and on the basis of a size of the edge area included in a prescribed area in the difference image.

6. The non-transitory computer-readable recording medium according to claim 5, wherein
the area information further indicates a batter area in which a batter is presumed to appear in the image that represents the pitching scene,
an angle formed by a direction perpendicular to a ground in the pitching scene and the prescribed direction is less than a prescribed angle,
the prescribed area is a remaining area obtained by removing the pitcher area and the batter area from the image that represents the pitching scene, and
the determining that the difference image represents the pitching scene determines that the difference image represents the pitching scene when the size of the edge area included in the pitcher area is larger than a first threshold and when the size of the edge area included in the prescribed area is equal to or smaller than a second threshold.

7. The non-transitory computer-readable recording medium according to claim 6, wherein
the batter area indicated by the area information includes a right-handed-batter area in which a right-handed batter is presumed to appear and a left-handed-batter area in which a left-handed batter is presumed to appear,
the determining that the difference image represents the pitching scene acquires batter information that indicates whether the batter presumed to appear in the image is the right-handed batter or the left-handed batter in the pitching scene, and
the determining that the difference image represents the pitching scene uses, as the prescribed area, a remaining area obtained by removing the pitcher area and the right-handed-batter area from the difference image when the batter information indicates the right-handed batter, and a remaining area obtained by removing the pitcher area and the left-handed-batter area from the difference image when the batter information indicates the left-handed batter.

8. The non-transitory computer-readable recording medium according to claim 6, wherein
the batter area indicated by the area information includes a right-handed-batter area in which a right-handed batter is presumed to appear and a left-handed-batter area in which a left-handed batter is presumed to appear, and
the determining that the difference image represents the pitching scene uses, as the prescribed area, a remaining area obtained by removing the pitcher area and the right-handed-batter area from the difference image when a size of the edge area included in the right-handed-batter area is larger than a size of the edge area included in the left-handed-batter area in the difference image, and a remaining area obtained by removing the pitcher area and the left-handed-batter area from the difference image when the size of the edge area included in the left-handed-batter area is larger than the size of the edge area included in the right-handed-batter area.

9. An image processing method comprising:
detecting, by a processor, an edge pixel from a difference image that represents a difference between a first image at a first time and a second image at a second time that are included in a video;
identifying, by the processor, an edge area in which a plurality of edge pixels are aligned in a prescribed direction in the difference image; and
referring to area information indicating a pitcher area in which a pitcher is presumed to appear in an image that represents a pitching scene, and determining, by the processor, that the difference image represents the pitching scene on the basis of a size of the edge area included in the pitcher area in the difference image and on the basis of a size of the edge area included in a prescribed area in the difference image.

10. The image processing method according to claim 9, wherein
the area information further indicates a batter area in which a batter is presumed to appear in the image that represents the pitching scene,
an angle formed by a direction perpendicular to a ground in the pitching scene and the prescribed direction is less than a prescribed angle,
the prescribed area is a remaining area obtained by removing the pitcher area and the batter area from the image that represents the pitching scene, and
the determining that the difference image represents the pitching scene determines that the difference image represents the pitching scene when the size of the edge area included in the pitcher area is larger than a first threshold and when the size of the edge area included in the prescribed area is equal to or smaller than a second threshold.

11. The image processing method according to claim 10, wherein
the batter area indicated by the area information includes a right-handed-batter area in which a right-handed batter is presumed to appear and a left-handed-batter area in which a left-handed batter is presumed to appear,
the determining that the difference image represents the pitching scene acquires batter information that indicates whether the batter presumed to appear in the image is the right-handed batter or the left-handed batter in the pitching scene, and
the determining that the difference image represents the pitching scene uses, as the prescribed area, a remaining area obtained by removing the pitcher area and the right-handed-batter area from the difference image when the batter information indicates the right-handed batter, and a remaining area obtained by removing the pitcher area and the left-handed-batter area from the difference image when the batter information indicates the left-handed batter.

12. The image processing method according to claim 10, wherein
the batter area indicated by the area information includes a right-handed-batter area in which a right-handed batter is presumed to appear and a left-handed-batter area in which a left-handed batter is presumed to appear, and
the determining that the difference image represents the pitching scene uses, as the prescribed area, a remaining area obtained by removing the pitcher area and the right-handed-batter area from the difference image when a size of the edge area included in the right-handed-batter area is larger than a size of the edge area included in the left-handed-batter area in the difference image, and a remaining area obtained by removing the pitcher area and the left-handed-batter area from the difference image when the size of the edge area included in the left-handed-batter area is larger than the size of the edge area included in the right-handed-batter area.
